(19) United States
(12) Patent Application Publication
(10) Pub. No.: US 2023/0257202 A1
(43) Pub. Date: Aug. 17, 2023

(54) HYDROGEN GAS SUBSURFACE STORAGE (HSS)

(71) Applicant: SAUDI ARABIAN OIL COMPANY, Dhahran (SA)

(72) Inventors: Abdulaziz S. Al-Qasim, Dammam (SA); Sunil Kokal, Dhahran (SA); Yuguo Wang, Dhahran (SA)

(73) Assignee: SAUDI ARABIAN OIL COMPANY, Dhahran (SA)

(21) Appl. No.: 17/651,531

(22) Filed: Feb. 17, 2022

(51) Int. Cl. B65G 5/00; F17C 1/00; C25B 1/04

(52) U.S. Cl. CPC B65G 5/00; C25B 1/04; F17C 1/007; F17C 2221/012; F17C 2223/0123; F17C 2270/0581

(57) ABSTRACT

A method of storing hydrogen gas in a subsurface formation may include compressing hydrogen gas by utilizing a compressor. This may create pressurized hydrogen gas that may be introduced into a subsurface formation through a wellhead to store as reserved hydrogen gas. The reserved hydrogen gas may be stored and maintained in the subsurface formations for a period. Another method in accordance with one or more embodiments of the present disclosure relates to recovering previously stored hydrogen gas from a subsurface storage for energy production. The method may include extracting reserved hydrogen gas from a subsurface formation. The extracted hydrogen gas may be purified by using at least a dehydrator, a pressure swing adsorption unit (PSA) and at least a temperature swing adsorption unit (TSA). The purified hydrogen gas may then be pressurized and used as a fuel for combustion in a turbine-generator unit.

### BACKGROUND

Hydrogen gas has many uses in applications, such as use in the chemical industry, as a fuel for transport, as well as a means for energy storage. In order to be used in these applications, hydrogen gas may be stored through various means. Storage of hydrogen gas underground may be useful for stabilizing power grid output in the operation of intermittent energy sources, such as solar or wind power, as well as providing fuel for electricity generation and transportation.

### SUMMARY

This Summary is provided to introduce a selection of concepts that are further described in the Detailed Description. This Summary is not intended to identify key or essential features of the claimed subject matter, nor is it intended to be used as an aid in limiting the scope of the claimed subject matter.

In one aspect, embodiments disclosed herein relate to a method of storing hydrogen gas in a subsurface formation. The disclosed method may include compressing hydrogen gas by utilizing a compressor. This may create pressurized hydrogen gas that may be introduced into a subsurface formation through a wellhead to store as reserved hydrogen gas. The reserved hydrogen gas may be stored and maintained in the subsurface formations for a period.

In another aspect, embodiments disclosed herein relate to a method of recovering previously-stored hydrogen gas from a subsurface storage. The recovered hydrogen gas may be used as a fuel for energy production. The method may include extracting reserved hydrogen gas from a subsurface formation. The extracted hydrogen gas may be further purified by using at least a dehydrator, a pressure swing adsorption unit (PSA), and at least a temperature swing adsorption unit (TSA). The purified hydrogen gas may then be pressurized and used as a fuel for combustion in a turbine-generator unit.

Other aspects and advantages of the claimed subject matter will be apparent from the following Detailed Description and the appended Claims.

### BRIEF DESCRIPTION OF DRAWINGS

FIG. 1 shows a schematic diagram of a hydrogen gas production, storage, and reserved hydrogen gas extraction for an energy production system in accordance with one or more embodiments.

FIG. 2 illustrates an electrolysis technique for producing hydrogen gas utilizing solar energy in accordance with one or more embodiments.

FIG. 3 illustrates a method for generating hydrogen gas and storing it in subsurface formations in accordance with one or more embodiments.

FIG. 4 illustrates a method for recovering hydrogen gas from subsurface formations and producing energy utilizing the reserved hydrogen gas in accordance with one or more embodiments.

### DETAILED DESCRIPTION

There is a demand for large volumes of hydrogen gas facilities and storage. Utilizing depleted oil and gas reservoirs, aquifers, and other subsurface formations may solve storage issues for large-scale subsurface storage of hydrogen gas. Storage sites in large volumes, such as at the subsurface formations in depleted oil fields, gas fields, deep saline, or other porous formations (shallow or deep) with appropriate seal and containment integrity may provide an easy to utilize, safe, and an efficient solution to hydrogen storage issues.

Hydrogen gas has uses in applications that may range from the chemical industry, transportation fuel, and a means for storing energy. Hydrogen gas may be stored in order to use in one or more applications, such as an energy source or as an energy storage medium. However, hydrogen gas is a low-density material: 1 kg (kilogram) of hydrogen gas occupies over 11 m³ (cubic meters) at room conditions. This means that a large amount of hydrogen gas necessarily requires a large volume to store under these conditions, or greater pressures and reduced temperatures must be utilized.

Throughout the application, ordinal numbers (for example, first, second, third) may be used as an adjective for an element (that is, any noun in the application). The use of ordinal numbers does not imply or create a particular ordering of the elements or limit any element to being only a single element unless expressly disclosed, such as by the use of the terms “before,” “after,” “single,” and other such terminology. Rather, the use of ordinal numbers is to distinguish between the elements. By way of an example, a first element is distinct from a second element, and the first element may encompass more than one element and succeed (or precede) the second element in an ordering of elements.

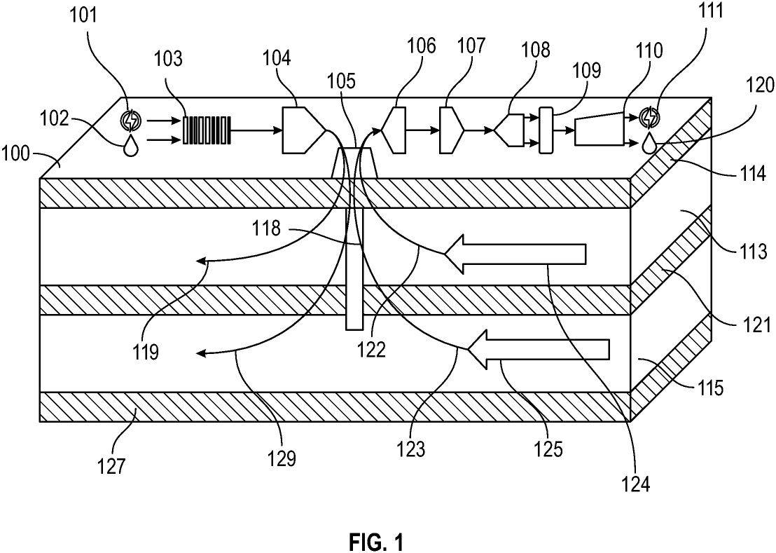

In the following description of FIGS. 1-4, any component described with regard to a figure, in various embodiments disclosed, may be equivalent to one or more like-named components described with regard to any other figure. For brevity, descriptions of these components will not be repeated with regard to each figure. Each and every embodiment of the components of each figure is incorporated by reference and assumed to be optionally present within every other figure having one or more like-named components. Additionally, in accordance with various embodiments disclosed, any description of the components of a figure is to be interpreted as an optional embodiment which may be implemented in addition to, in conjunction with, or in place of the embodiments described with regard to a corresponding like-named component in any other figure.

It is to be understood that the singular forms “a,” “an,” and “the” include plural referents unless the context clearly dictates otherwise. Thus, for example, reference to “a horizontal beam” includes reference to one or more of such beams.

Terms such as “approximately” or “substantially” mean that the recited characteristic, parameter, or value need not be achieved exactly, but that deviations or variations, including, for example, tolerances, measurement error, measurement accuracy limitations, and other factors known to those of skill in the art, may occur in amounts that do not preclude the effect the characteristic was intended to provide.

It is to be understood that one or more of the steps shown in the flowcharts may be omitted, repeated, or performed in a different order than shown. Accordingly, the scope disclosed should not be considered limited to the specific arrangement of steps shown in the flowcharts.

Although multiple dependent claims are not introduced, it would be apparent to one of ordinary skill that the subject matter of the dependent claims of one or more embodiments may be combined with other dependent claims.

For the purposes of this application, a “formation” is a contiguous subsurface geological structure. A “reservoir” is a type of formation that that may retain a fluid within its contiguous structure, such as freshwater, brine, crude oil, condensates, or natural gas. A hydrocarbon-bearing reservoir may currently be under hydrocarbon production or may have previously been under hydrocarbon production. A reservoir is a formation, but a formation may not be a reservoir.

The term “wellbore” refers to a hole drilled in the ground in order to look for or extract natural resources such as oil and gas. Wellbores are usually drilled in order to penetrate a reservoir that contains hydrocarbons, and such hydrocarbons are recovered to bring on a surface from the underground reservoir by extraction through a wellbore. A wellbore is also known as a borehole and may be cased with cement and steel to increase formation stability. The surface end of a wellbore may be referred to as the “uphole” end; the end of the wellbore distal from the uphole end is the “downhole” end of the wellbore. This terminology is consistent despite the overall orientation of the wellbore at a given point: vertical, approximately vertical, deviated, approximately horizontal, and horizontal.

For the purpose of this application, an overburden, an intermediate formation, and an underburden are considered formations that are impermeable to gas transport through the matrix of their geological structure, that is no migration occurs through these formations. The overburden, an intermediate formation, and an underburden are not reservoirs.

A “depleted” reservoir is a reservoir that has previously produced fluid from the formation, such as water or hydrocarbons. A depleted reservoir typically contains remaining or “residual” fluids, such as hydrocarbons. In such depleted reservoirs, the fluids are no longer economically viable for commercial production.

A “storage reservoir” is a reservoir configured to store one or more fluids, such as gases, liquids, and combinations thereof, that did not originate from the storage reservoir from which these gases were produced. Storage reservoirs may include, but are not limited to, active and depleted crude oil, condensate, or hydrocarbon gas reservoirs; non-hydrocarbon gas reservoirs, such as those containing carbon dioxide or hydrogen sulfide; aquifers, including brines and fresh water; and “dry” subsurface porous formations with appropriate seal and containment integrity to be a suitable reservoir for a fluid.

In one or more embodiments, the storage reservoir is any type of subsurface geological formation that is configured to hold gas for an extended period without detectable leakage. In one or more embodiment, 1-3% of working gas may possibly be lost depending on the seal of the formation for hydrogen storage. For a tightly sealed storage reservoir, the loss of working gas may be less than 1%, or less than 0.9%, or less than 0.7%, or less than 0.5%, or less than 0.3%, or less than 0.1%. This may include but is not limited to, depleted, active, and non-produced (“virgin”) hydrocarbon reservoirs.

The term “electrolysis” is a technique that uses direct electric current to drive an otherwise non-spontaneous chemical reaction. For example, the electrolysis of water is the process of using electricity to electrochemically decompose water into oxygen and hydrogen. The term “electrolyzer” refers to a unit where this chemical reaction may take place.

Hydrogen gas may be stored in the underground, large volume storage that is an efficient and safe manner for future use according to one or more embodiment. In one or more embodiments, disclosed is a method and system for storing hydrogen gas in the subsurface formation. In another embodiment, this method and system may be used to store other gases in the subsurface formation, a non-limiting example of which may be light hydrocarbons such as natural gas.

In one or more embodiments, the system may be used for thermal cracking of hydrocarbons stored in the subsurface formation to produce carbon in the solid form and hydrogen. A non-limiting example reaction of such thermal cracking may be CH₄ -> C + 2H₂. The disclosure builds on the art of hydrogen gas production from renewable energy sources, effective storage of hydrogen gas in bulk volume in underground storage, such as subsurface formations, for future use, and utilizing this subsurface reserved hydrogen gas for future energy production. The disclosed embodiment may utilize a system for energy conversion, hydrogen gas production, hydrogen gas transport, and energy distribution, and integrates a new large-volume hydrogen gas storage technique.

FIG. 1 shows a schematic diagram of a hydrogen gas production, storage, and reserved hydrogen gas extraction for an energy production system. As shown in FIG. 1, a well environment where there are two operational regions on and below the surface of the Earth (“surface”) 100.

On the surface 100, there are two sets of equipment coupled in series: one set is used for storing hydrogen gas underground and the other set is used for recovering the stored hydrogen gas for use. The two sets are in fluid communication with one another through a common storage reservoir.

The first set of equipment units includes an electrolyzer 103, a compressor 104, a turbine-generator 110, and a wellhead 105. An electricity source 101 and a water source 102 are utilized as feed for the electrolyzer 103. The other set of equipment includes the wellhead 105, a dehydrator 106, a pressure swing adsorption unit (PSA) 107, a temperature swing adsorption unit (TSA) 108, temporary storage for extracted hydrogen gas on surface 109, and the turbine-generator 110 - all coupled in series. The turbine-generator 110 produces electricity 111 and water 120 by utilizing the stored hydrogen gas.

Below the surface 100, the hydrogen gas storage and part of operation system include a first sealing zone 114, a second sealing zone 121, a third sealing zone 127, a wellbore 118, a shallow reservoir 113, a deep reservoir 115, a hydrogen gas injection assembly 119, and carbon dioxide injection assembly 129.

The first sealing zone 114, the second sealing zone 121, and the third sealing zone 127 are essentially the overburden, an intermediate formation, and an underburden, respectively, in this instance.

The shallow reservoir 113 may be, but is not limited to, a Neogene aquifer or shallow depleted hydrocarbon reservoir. The shallow reservoir 113 is located near the surface below the first sealing zone 114 and above the second sealing zone 121. The shallow reservoir 113 may include a porous or fractured rock formation that resides underground immediately beneath surface 100. The shallow reservoir 113 may include different layers of rock having varying characteristics, such as varying degrees of permeability, porosity, capillary pressure, and resistivity.

The deep reservoir 115 may be but is not limited to, a water aquifer, a depleted hydrocarbon reservoir, or a salt cavern. The deep reservoir 115 is located deeper into the underground. The deep reservoir 115 is situated below the second sealing zone 121 that separates the deep reservoir 115 from shallow reservoir 113. The third sealing zone 127 is situated beneath the deep reservoir 115. The deep reservoir 115 may include different layers of rock having varying characteristics, such as varying degrees of permeability, porosity, capillary pressure, and resistivity. In one or more embodiments, a plurality of wellbores may be utilized for the disclosed method.

The hydrogen gas transportation system includes a wellhead 105, a wellbore 118 that extends from the surface 100 into a subsurface formation, such as deep reservoir 115, a hydrogen gas injection assembly 119, a carbon dioxide injection assembly 129, a hydrogen gas extractor assembly 122 to extract stored hydrogen gas in shallow layer 124, and a carbon dioxide extractor assembly 123 to extract stored carbon dioxide gas stored in deep layer 125. The wellbore 118 may facilitate the transportation of hydrogen gas from surface 100 to one or more reservoirs, coupling the injection operations, or the communication of monitoring devices (for example, logging tools) introduced into the shallow reservoir 113 or deep reservoir 115 during monitoring operations (for an example, during in situ logging operations). In one embodiment, the hydrogen storage and recovery processes may be continuous processes. In another embodiment, the hydrogen storage and recovery processes may be batch processes. Both of the hydrogen storage and recovery processes may be done simultaneously, or seasonally. For a non-limiting example, hydrogen may be stored in the hydrogen storage for seasonal use during a low-demand season, and later may be recovered during a high-demand season. Demand may be referred to as the energy needed by a user.

In order to be able to store a gas, a subsurface storage formation is bound both above and below by formations less permeable to the gas than the subsurface storage formation. These formations should be substantially impermeable to the gas so as to prevent detectable leakage. In one or more embodiments, less than 0.1% annual loss of hydrogen gas from the subsurface storage formation may be permissible. In one or more embodiments, less than 0.01% annual loss of hydrogen gas from the subsurface storage formation may be permissible. The term, “impermeability” may mean that hydrogen molecules are not able to diffuse through the rock formations, and the formations are tightly sealed such that there may not be any leak. These intermediate formations would hinder the migration of the gas from the subsurface storage formation. In other words, the subsurface storage formations are bound by rock layers with nearly zero permeability to the stored gas. In one or more embodiments, the permeability of hydrogen gas in the intermediate formations, both above and below the subsurface storage formation, may be less than 0.1 millidarcy. In one or more embodiments, the rock layers above and below a subsurface formation may have near-zero permeability. The sealing zones above and below the depleted reservoir and above and below the hydrogen gas storage may have close to zero permeability although, in some situations, the permeability may be less than 1%. In contrast, the subsurface storage formation needs to have a permeability to the stored gas that is great enough to permit introduction and mobility through the subsurface storage formation. In one or more embodiments, the permeability of the subsurface storage formation to hydrogen gas may be greater than 1 millidarcy.

In one or more embodiments, hydrogen gas is introduced into a subsurface formation such as a depleted reservoir.

In one or more embodiments, this hydrogen gas is extracted from the storage reservoir and moved to the surface. At the surface, in one or more embodiments, the reserved hydrogen after extraction is introduced into a decompressor unit where the hydrogen gas is depressurized and then passed through a gas turbine coupled to a power generator such that hydrogen is burned and power is generated.

In one or more embodiments, the hydrogen gas may be further refined to increase its purity. In one or more embodiments, after recovering hydrogen gas from a first storage reservoir, any impurities, such as carbon dioxide, are separated from the depressurized product gas mixture before utilizing the depressurized product gas mixture as a source for energy production. In one or more embodiments, the stored hydrogen gas be may inert or non-reactive to the other natural gases present in the subsurface formation under conventional operation conditions.

In one or more embodiments, the hydrogen gas is introduced into a first storage reservoir such as a deeper reservoir or a shallow reservoir. In one or more embodiments, both or either the introduction of hydrogen gas into and extraction of hydrogen gas from the first storage reservoir may be a continuous, periodic, intermittent, or irregularly-scheduled process.

In one or more embodiments, recovered carbon dioxide gas from natural gas processing operations may be introduced into a second storage reservoir such as a deeper reservoir or a shallow reservoir, which is not the first storage reservoir. In some instances, the carbon dioxide may be refined to increase its purity before introducing it into a storage reservoir.

In one or more embodiments, hydrogen gas is stored in a first storage reservoir, which is a shallow storage reservoir, and carbon dioxide is stored in a second storage reservoir, which is a deep storage reservoir. In one or more embodiments, carbon dioxide gas is stored in a second storage reservoir, which is a shallow storage reservoir, and hydrogen is stored in a first storage reservoir, which is a deep storage reservoir.

In one or more embodiments, after separation from the product gas mixture, the hydrogen gas mixture may be introduced into more than one storage reservoir.

In one or more embodiments, the subsurface formations may be situated either beneath the surface or deep down where depleted hydrocarbon reservoirs typically form. These depleted hydrocarbon formations may be sealed from top and bottom by rock, earth formations.

In one or more embodiments, the produced hydrogen gas from the storage reservoir may be utilized for various applications, such as the production of electricity.

The embodiment methods allow for hydrocarbon reservoirs with low productivity to be further utilized for energy production and commercial utilization. It also allows for hydrogen gas to be produced and stored underground for later use. In addition, carbon dioxide may be stored underground in a separate storage reservoir for effectively permanent sequestration or use later.

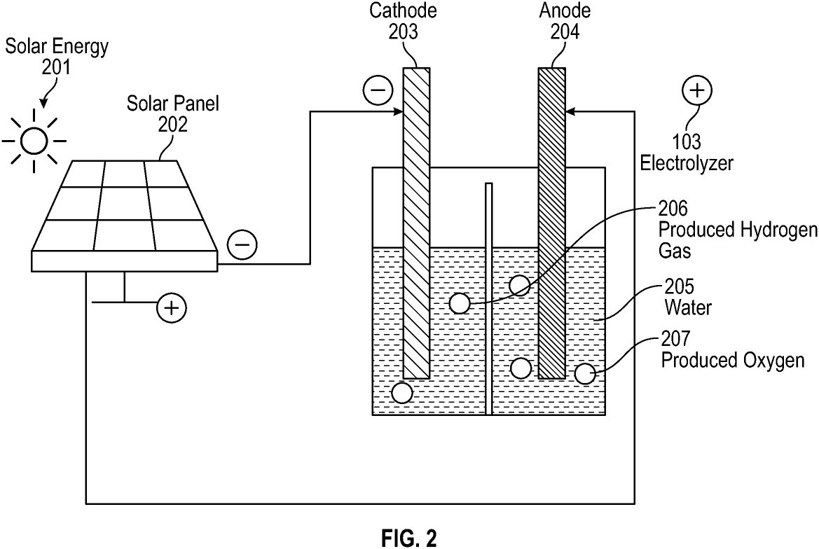

FIG. 2 illustrates an electrolysis technique for producing hydrogen gas from water. Hydrogen gas may be produced from water by using differing configurations, materials, and method steps are known to those skilled in the art.

As shown in FIG. 2, an electrolyzer 103, including a cathode 203 and an anode 204, all are electrical communication with a solar panel 202 that converts solar energy 201 into electricity. When an electric current is passed through water 205, water 205 is electrochemically decomposed into hydrogen gas 206 and oxygen 207. This hydrogen gas 206 produced may be collected for subsurface storage.

In one or more embodiments, a variety of methods for hydrogen production may utilize techniques that may produce zero or near-zero carbon dioxide emissions. A non-limiting example of such a hydrogen production technique may be the electrolysis technique. In one or more embodiments, hydrogen may be sourced from conventional oil and gas operations and stored under subsurface formations utilizing the disclosed method. In some embodiments, the stored hydrogen gas may be a mixer of hydrogen gas produced by utilizing renewable energies and hydrogen gas produced from conventional oil and gas operations.

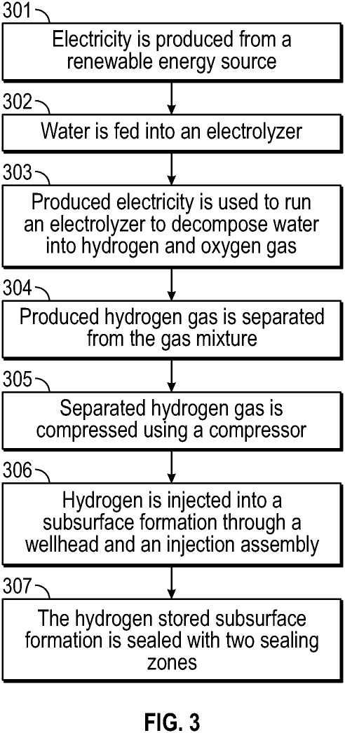

FIG. 3 illustrates a method for generating hydrogen gas and storing it in a subsurface formation. Embodiment methods include generating hydrogen gas from the electrochemical decomposition of water by utilizing a renewable energy source and storing the produced hydrogen gas in a storage reservoir may comprise several steps.

The systems for generating hydrogen gas from a renewable energy source and storing hydrogen gas in a storage reservoir may comprise several elements. Specifically, the systems may comprise a renewable energy source, water, an electrolyzer, a compressor, and a wellhead coupled to a wellbore defined by a wellbore wall that traverses the subsurface, including the storage reservoir.

In method shown in FIG. 3, electricity is produced from a renewable energy source, including, but not limited to, solar energy 301. For example, a plurality of solar panels may be used to convert solar energy into electricity. In one or more embodiments, the produced electricity may be stored in batteries and the electrolysis process may occur continuously. In one or more embodiments, the produced electricity may be stored in batteries and the electrolysis process may occur diurnally. In one or more embodiments, the electrochemical process may be more efficient when the temperature is lower and heat can be better removed; such as at night. In other embodiments, the renewable energy source is wind energy, and a plurality of wind turbines may be used to generate electricity.

Step 302 is that water is introduced into the electrolyzer. The water may be sourced from natural resources, one of which is rainwater. The water may be sourced from an artificial source, such as a condensed vapor product of electrical generation utilizing hydrogen and a source of oxygen, such as air. Water may be produced from a power generator that utilizes hydrogen and oxygen for combustion and may be recycled into feed for the electrolyzer. In one or more embodiments, the water may comprise one or more known compositions of water, including distilled; condensed; filtered, or unfiltered fresh surface or subterranean waters, such as water sourced from lakes, rivers, or aquifers; mineral waters; gray, brown, black, and blue waters; run-off, storm or wastewater; potable or non-potable waters; brackish waters; synthetic or natural sea waters; synthetic or natural brines; formation waters; production water; boiler feed water; condensate water; and combinations thereof. The water may include impurities, including, but not limited to, ions, salts, minerals, polymers, organic chemicals, inorganic chemicals, detritus, flotsam, debris, and dead and living biological life forms, so long as the purpose and performance of the electrochemical process are not mitigated or otherwise detrimentally affected.

Step 303 of a method may include that electricity is transmitted to the electrolyzer such that hydrogen gas and oxygen are produced from the electrochemical decomposition of water within the electrolyzer.

Step 304 of the method may include separating hydrogen gas from the hydrogen and oxygen gas mixture and creating a separated hydrogen gas stream. In one or more embodiments, the separated hydrogen gas may be further be refined after separation before compression to reduce any impurities. In one or more embodiments, hydrogen and oxygen gases may be naturally separated by setting the anode and cathode into a different compartment for the electrolyzer such that there is no fluid contact between the two compartments.

The hydrogen gas may be compressed utilizing a compressor and then transported to a wellhead over a surface, as shown in step 305. The wellhead may be coupled to a storage reservoir through a wellbore.

The compressed hydrogen gas may then be introduced into a storage reservoir, such as a depleted hydrocarbon reservoir, through an assembly of injectors passing through the wellbore, as shown in step 306. In one or more embodiments, hydrogen gas may be pumped into the reservoir by utilizing a compression method, such as using a compressor. In one or more embodiments, pipelines composed of metal alloys that may prevent hydrogen may be utilized for hydrogen gas transportation. The hydrogen gas stored subsurface formation may be sealed with two sealing zones as step 307 to restrict hydrogen gas loss.

In one or more embodiments, hydrogen gas may be pressurized, that is, raised to a value greater than atmospheric pressure, prior to introduction into the subsurface formations. In one or more embodiments, the physical state of the hydrogen stored in a subsurface formation may be gaseous under the subsurface formation conditions. In one or more embodiments, the pressure of hydrogen gas may be greater than 100 psi. In one or more embodiments, the pressure of hydrogen gas is in a range of from about 870 to about 2600 psi (pounds per square inch). In one or more embodiments, to introduce compressed hydrogen gas in the subsurface formations, a pressure higher than expected stored pressure in the geological formation ranging from 870 psi to about 2600 psi may be applied.

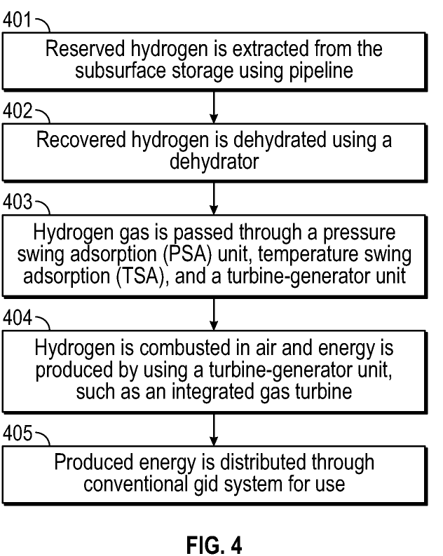

FIG. 4 illustrates a method for recovering hydrogen gas from subsurface formations and producing energy utilizing the reserved hydrogen gas. As shown in step 401, hydrogen gas is produced from the subsurface formations.

The produced hydrogen gas is processed on the surface using several different processes. The produced hydrogen gas is dehydrated in step 402 to remove any water impurities from the storage reservoir. The dehydrated hydrogen gas is then passed through both a pressure swing adsorption unit (PSA) and a temperature swing adsorption unit (TSA) in step 403 to form purified hydrogen gas. In one or more embodiments, the combination of the PSA and TSA may help remove impurities such as light hydrocarbons, CO₂, H₂S, N₂, and water from the dehydrated hydrogen gas.

In one or more embodiments, a heat exchanger may be optionally utilized to provide process heat from the produced hydrogen gas. In one or more embodiments, the energy produced from the hydrogen gas may be stored through various means. These may include but are not limited to, compressed air energy storage, water elevation energy storage, batteries, supercapacitors, and other electrical energy storage. In one or more embodiments, the energy may be stored in a form of water elevation energy or using the energy for pumping water up to a reservoir where it can then flow down to a generator when needed. In one or more embodiments, the energy may be stored in a form of compressed-air energy storage. In other embodiments, the energy may be stored in a form of flying wheel, and electromagnetic energy. In yet other embodiments, the heat energy from the hot gases may be used as an energy source other than in a turbine, such as using the hot gases in a heat exchanger to provide heat for a process.

Converting the purified hydrogen gas into electricity again may utilize one or more of a turbine-generator unit to generate electricity as shown in step 404. In one or more embodiments, an example of such a turbine-generator is an integrated gas turbine (IGT) to combust the hydrogen in the presence of oxygen or air and create a hot gas stream that can be passed through such a gas turbine. The gas turbine can extract the thermal and pressure drop across the turbine. In some other instances, high-pressure steam can be created from the combustion of hydrogen and oxygen, and then the remainder may be passed across a turbine. In such an integrated gas turbine (IGT), heat energy is converted into mechanical energy by passing the elevated temperature gas such as steam through a turbine but also the same gas through a heat exchanger to create high-pressure steam. The post-combustion gas mixture or steam may be of sufficient heat and volume to drive a turbine and generate mechanical energy. The resultants are not only the production of power in some form but also a cooler, depressurized hydrogen gas. Passing the post-combustion gas mixture through a turbine result not only in a temperature reduction but also a pressure reduction having translated the thermal energy of the gas into mechanical energy. Other methods for extracting energy from the hydrogen gas may also be employed, such as heat exchangers to create high-pressure steam, as previously suggested, or to facilitate chemical reactions in a reaction vessel or combustion of the product gas to provide energy for electrical energy generation. In one or more embodiments, combustion of hydrogen gas may produce high temperature and high-pressure steam, that may be sufficient to generate high pressure steam using the heat exchanger.

The produced electricity is further distributed with a conventional grid system for use, as shown in step 405. Other means of power generation utilizing the extracted hydrogen are envisioned.

In one or more embodiments, oxygen gas may be separated after electrolysis and stored in conventional methods for future use. In one or more embodiments, oxygen gas may be used for the combustion of hydrogen gas when hydrogen gas is extracted from the geological formation for energy production. As a non-limiting example, oxygen gas may be used for combustion processes such as oxy-combustion for the reduction of CO₂ emission in gas-fired power plants.

In one or more embodiments, energy may be extracted from the impurities present in the produced hydrogen gas. For example, the produced hydrogen gas may contain a significant fraction of light hydrocarbons present as impurities, which have an elevated temperature. Such light hydrocarbons may be separated from the hydrogen gas and passed through a gas turbine for the purpose of energy production, such as for creating electricity. In one or more embodiments, a temperature and pressure range for this recovered hydrogen gas/or produced hydrogen gas may range from 50 to 150° C. and from 100 to 2600 psi, respectively. In one or more embodiments, light hydrocarbons may be present in the extracted hydrogen gas and may be utilized for combustion along with the hydrogen gas without any further separation process.

In one or more embodiments, the hydrogen gas mixture after recovering from subsurface storage, and prior to passing through any further process may have purity in a range of greater than 50% hydrogen gas, such as greater than 60%, such as greater than 70%, such as greater than 80%, such as greater than 90%, such as greater than 95%, such as greater than 98%, such as greater than 99%, such as greater than 99.9%. The purity of hydrogen gas may be calculated as the purity in mole percentage. In one or more embodiments, the hydrogen gas mixture may comprise components other than hydrogen gas that may include but are not limited to, CO₂, CO, H₂O, N₂, small chain hydrocarbons, H₂S. In one or more embodiments, the purity of hydrogen gas may be highly dependent on the application and vary without any limitation. For a non-limiting example, if hydrogen gas is used for combustion processes to produce energy, further separation processes may not be needed. In yet another example, if hydrogen gas is utilized for a hydrogen fuel cell to generate electricity, the purity of hydrogen gas needed may be above 99.9%, therefore, further separation processes may be used for purification of extracted hydrogen gas before being utilized as a fuel source. In another example, if extracted hydrogen gas is utilized for a high-temperature fuel cell to generate electricity, no separation process may be needed.

In one or more embodiments, the hydrogen gas recovered from the depressurized reserved gas mixture may have other impurities. During the one or more separation processes, hydrogen gas may be accompanied by oxygen gas separated from the depressurized product gas mixture.

In one or more embodiments, the hydrogen gas recovered from the depressurized reserved gas may have purity in a range of greater than 50% hydrogen gas, such as greater than 60%, such as greater than 70%, such as greater than 80%, such as greater than 90%, such as greater than 95%, such as greater than 98%, such as greater than 99%, such as greater than 99.9%. In one or more embodiments, impurities may include H₂O, CO₂, N₂, light hydrocarbon molecules such as CH₄, C₂H₆.

In one or more embodiments, other components may be present along with reserved hydrogen gas as well, such as oxygen gas, water; light hydrocarbons (LHC), such as alkanes, olefins, aromatics; and other gases and liquids.

In one or more embodiments, light hydrocarbons may be recovered during the separation processes. The light hydrocarbons, once recovered, may be recycled, combusted, and then directed back to the turbine for more energy production.

In one or more embodiments, energy from the combustion of the light hydrocarbons may be used to power surface processes such as separation.

In one or more embodiments, carbon dioxide may be injected in a separate injection assembly into the subsurface formations.

In one or more embodiments, one or more of the recovered hydrogen gas streams may be put through a scrubber to remove contaminants.

In one or more embodiments, if hydrogen gas or carbon dioxide are going to be separated from the gas mixture via membranes, it may be desired to separate various heavier components prior to separating hydrogen gas or carbon from the gas mixture in order to prevent fouling in the membranes.

Once stored, the hydrogen gas may be removed from the subsurface storage formation and produced to the surface at any time. In one or more embodiments, the recovered hydrogen gas may have significant amounts of impurities due to the long-term storage in subsurface formations. These impurities may include but are not limited to low chain hydrocarbons. The hydrogen gas mixture may be further refined utilizing specialized hydrogen gas-based processes that are known to those skilled in the art. These techniques may include but are not limited to, dehydration, pressure swing adsorption unit (PSA), temperature swing adsorption unit (TSA), and membrane separation. Separation of hydrogen gas from other materials may take the form of a combination of these or other techniques in order to obtain hydrogen gas of sufficient purity for use in the intended applications.

Embodiments of the present disclosure may provide at least one of the following advantages. Stored hydrogen can be utilized for various applications, such as the production of electricity or in pressure maintenance in gas reservoirs or reservoirs with a gas cap. The embodiment methods allow for hydrocarbon reservoirs with low productivity to be further utilized for energy production and commercial utilization. It also allows for hydrogen to be produced and stored underground for later use.

Embodiment systems may have various configurations capable of providing power to components on the surface. Power may be able to be provided by sources that include but are not limited to, solar panels, an electrical grid, waste heat, geothermal energy, and combustion of gases such as recovered light hydrocarbons or H₂S. There may be couplings configured to transfer power from one or more of these sources and one or more components on the surface. These may include components of a hydrogen injection support system, such as a compressor, or various pieces of equipment capable of separating hydrogen from the product gas mixture. Energy from gas streams on the surface may provide power to surface components from various systems, such as a hydrogen injection support system. In one or more embodiments, waste heat may be available for transfer to separation processes. In one or more embodiments, power may be transferred from these sources to one or more of these components on the surface for the execution of various steps of embodiment methods.

Method 1 is one embodiment. Other embodiments for hydrogen gas production and storage are also possible, in addition to that depicted in FIG. 3. For example, other configurations for optional energy extraction from the product gas mixture may be employed. In addition, other configurations may also be possible, including those described in other embodiments herein.

While the disclosure has been described with respect to a limited number of embodiments, those skilled in the art, having the benefit of this disclosure, will appreciate that other embodiments may be devised which do not depart from the scope of the disclosure as disclosed herein. Accordingly, the scope of the disclosure should be limited only by the attached claims.

Although the preceding description has been described herein with reference to particular means, materials, and embodiments, it is not intended to be limited to the particulars disclosed herein; rather, it extends to all functionally equivalent structures, methods, and uses, such as are within the scope of the appended claims. In the claims, means-plus-function clauses are intended to cover the structures described herein as performing the recited function and not only structural equivalents but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. §112(f) for any limitations of any of the claims herein, except for those in which the claim expressly uses the words ‘means for’ together with an associated function.

What is claimed:

1. A method, comprising:
compressing a hydrogen gas into a pressurized hydrogen gas by utilizing a compressor;
introducing the pressurized hydrogen gas into a subsurface formation through a wellhead to form a reserved hydrogen gas; and
maintaining the reserved hydrogen gas in the subsurface formation for a period.

2. The method of claim 1, further comprising:
generating electrical power utilizing a renewable energy source;
producing a gas mixture comprising the hydrogen gas and an oxygen gas via an electrochemical decomposition of water utilizing renewably generated electrical power; and
separating the hydrogen gas from the gas mixture for subsurface storage.

3. The method of claim 2, further comprising purifying the hydrogen gas after separating the hydrogen gas from the gas mixture and before introducing purified, pressurized hydrogen gas into the subsurface formation.

4. The method of claim 2, wherein an electrolyzer unit is utilized to perform the electrochemical decomposition of water.

5. The method of claim 3, wherein an electrolyzer unit is used for decomposition of water and is fluidly coupled with upstream of the compressor, and the compressor is fluidly coupled with upstream of the wellhead.

6. The method of claim 1, wherein purity of the pressurized hydrogen gas may range from 50 to 100% depending on an application.

7. The method of claim 1, wherein the wellhead comprises both fluid couplings and signal couplings for equipment positioned below a surface.

8. The method of claim 2, wherein the renewable energy source is solar energy, and a plurality of solar panels are used for generating electricity power.

9. The method of claim 2, wherein the renewable energy source is wind energy, and a plurality of wind turbines are used for generating electricity power.

10. The method of claim 2, wherein the water used for producing hydrogen gas through electrolysis is sourced from rainwater.

11. The method of claim 1, wherein stored hydrogen gas is introduced into an additional subsurface storage formation before transporting into larger volume subsurface formations.

12. The method of claim 2, further comprising separating oxygen gas from the gas mixture and storing the oxygen gas in a conventional method for future use.

13. A method, comprising:
extracting a reserved hydrogen gas from a subsurface to form an extracted hydrogen gas;
purifying the extracted hydrogen gas utilizing at least a dehydrator, a pressure swing adsorption unit (PSA) and at least a temperature swing adsorption unit (TSA) to produce a purified hydrogen gas;
pressurizing the purified hydrogen gas to produce a pressurized hydrogen gas; and
producing energy by combusting the pressurized hydrogen gas in a turbine-generator unit.

14. The method of claim 13, wherein produced energy is utilized as electricity or heat.

15. The method of claim 13, further comprising distributing produced energy in a conventional power grid system for use.

16. The method of claim 14, wherein the reserved hydrogen gas further comprises impurities.

17. The method of claim 14, wherein the extracted hydrogen gas is passed through a separation unit to remove impurities.

18. The method of claim 13, wherein the extracted hydrogen gas is passed through a dehydrator such that purity of dehydrated hydrogen gas is at least 50%.

19. The method of claim 13, wherein the dehydrator also produces water.
